(19) United States
(12) Patent Application Publication
(10) Pub. No.: US 2018/0097998 A1
(43) Pub. Date: Apr. 5, 2018

(54) SPECTRUM DISPLAY METHOD AND SYSTEM WITH PHOTOGRAPHIC FUNCTION

(71) Applicant: Glit Technologies (Shenzhen) Pte Ltd, Shenzhen (CN)

(72) Inventors: Gaoqiang Yuan, Shenzhen (CN); Xiang Pan, Shenzhen (CN)

(21) Appl. No.: 15/817,194

(22) Filed: Nov. 18, 2017

Related U.S. Application Data
(63) Continuation of application No. PCT/CN2016/082398, filed on May 17, 2016.

(30) Foreign Application Priority Data
May 25, 2015 (CN) 201510270666.3

(51) Int. Cl. H04N 5/232; H04N 5/76; G01N 21/27

(52) U.S. Cl. CPC H04N 5/23293; G01N 2201/126; G01N 21/27; H04N 5/76

(57) ABSTRACT

A spectrum display method with photographic function includes collecting spectrum data and image data of a sample measurement device, controlling to display the spectrum data and the image data, recording the image data of the sample measurement device according to commands of shooting or recording the sample measurement device, associating the image data with the spectrum data, putting the associated data into an experiment image storage window, and performing operations of viewing, comparing, or editing the associated data; or saving the associated data as a record file; and loading the saved record file for performing the operations of viewing, comparing, or editing the record file. The image data includes photo data generated by shooting the sample measurement device or recorded video data generated by recording of the sample measurement device. A spectrum display system with photographic function is also provided.

### CROSS REFERENCE TO RELATED APPLICATIONS

The present application is a Continuation Application of PCT Application No. PCT/CN2016/082398 filed on May 17, 2016, which claims the benefit of Chinese Patent Application No. 201510270666.3 filed on May 25, 2015. All the above are hereby incorporated by reference.

### FIELD

The subject matter herein generally relates to a spectrometer.

### BACKGROUND

A spectrograph function software is used to measure and display spectral curve and spectral data.

### BRIEF DESCRIPTION OF THE DRAWINGS

Implementations of the present technology will now be described, by way of example only, with reference to the figures.

FIG. 1 is an operation interface view of an embodiment of a spectrograph function software of a prior art.

FIG. 2 is a flowchart of one exemplary embodiment of a spectrum display method with photographic function.

FIG. 3 is a block diagram of one exemplary embodiment of a spectrum display system with photographic function.

FIG. 4 is a block diagram of one exemplary embodiment of a hardware system.

FIG. 5 is a schematic diagram of an embodiment of an interface of a spectrograph with a photographic and/or video function.

FIG. 6 is a partial schematic diagram of an embodiment of a software interface of a host computer.

FIG. 7 is a system architecture diagram of an embodiment of the spectrum display system with photographic function.

FIG. 8 is an operating flowchart of an embodiment of the spectrum display system with photographic function.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure described in relation to a spectrum display method and system with photographic function.

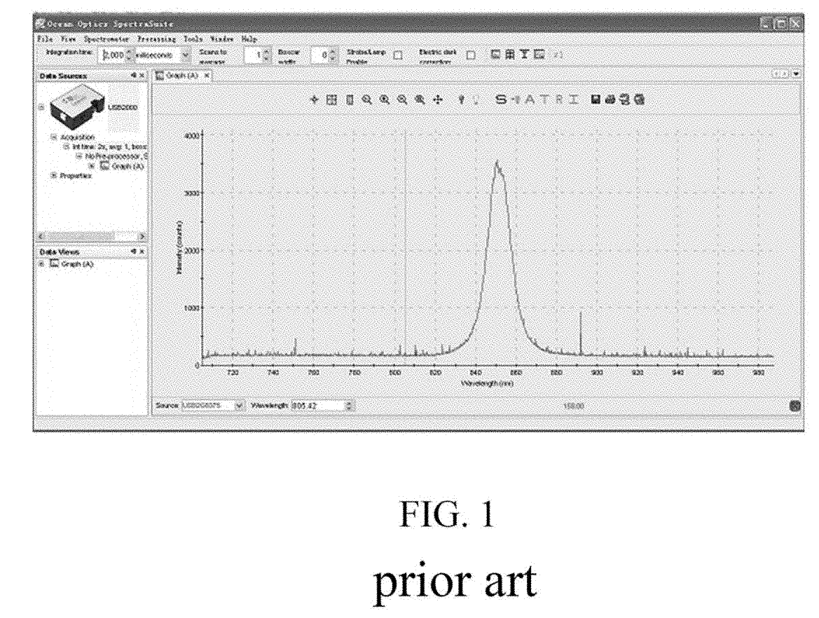

FIG. 1 illustrates an embodiment of an operation interface of a spectrograph function software of a prior art. The spectrograph function software is a software of a spectrometer of Ocean Optics Inc.

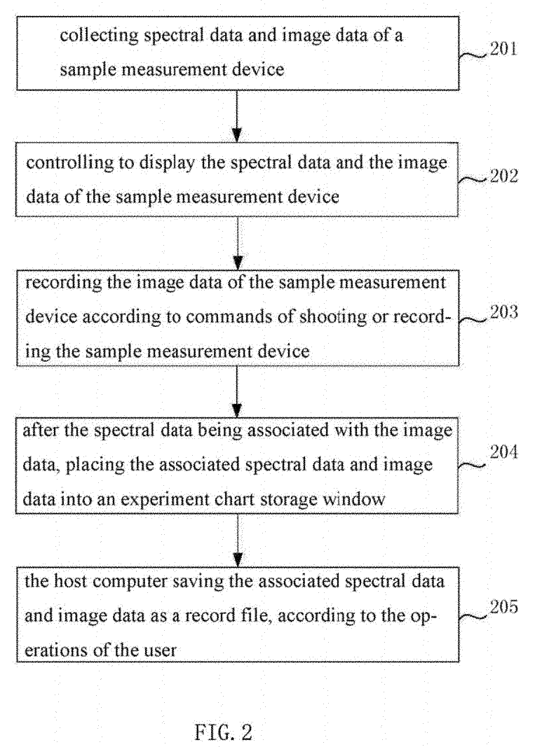

FIG. 2 illustrates a flowchart of a method in accordance with an example embodiment. A spectrum display method with photographic function is provided by way of example, as there are a variety of ways to carry out the method. The illustrated order of blocks is by example only and the order of the blocks can change. Additional blocks may be added or fewer blocks may be utilized without departing from this disclosure. The spectrum display method with photographic function can begin at block 201.

At block 201, collecting spectral data and image data of a sample measurement device. The sample measurement device comprises a sample. Specifically, the spectral data is collected by a spectrometer, the image data of the sample measurement device is collected by a shooting device, such as a camera or a video recorder, and the collected spectral data and image data are transmitted to a host computer.

At block 202, controlling to display the spectral data and the image data of the sample measurement device. Specifically, controlling the spectral data and the image data of the sample measurement device to display on the host computer, the host computer displays the spectral data and the image data of the sample measurement device in real time after receiving the spectral data from the spectrometer and the image data from the shooting device. The spectral data displayed on the host computer can be spectral curves, optical chromatograms, and spectral data lists, which are generated from the spectral data. The spectral curve, the optical chromatogram, and the spectral data lists are described in detail later.

At block 203, recording the image data of the sample measurement device according to commands of shooting or recording the sample measurement device. The image data comprises photo data of shooting the sample measurement device or recorded video data of recording the sample measurement device. Specifically, the host computer generates corresponding commands for taking photos or recording video, according to operations of a user (such as clicking a photo button or video recording button), and records the image data or video data of the sample measurement device according to the commands. The operations of the user comprise an operation of clicking a photo button or an operation of clicking a video record button.

At block 204, after the spectral data being associated with the image data, placing the associated spectral data and image data into an experiment chart storage window for viewing, comparing, or editing the associated data. The block 204 also comprises a step of loading the saved and associated image data and spectral data through the commands for viewing, comparing, or editing the associated data. The experiment chart storage window is in an image record module.

At block 205, the host computer saving the associated spectral data and image data as a record file, according to the operations of the user. The record file can be displayed, be saved, be edited, be opened, be called, be copied, or be printed. The image data can also be saved separately as a record file according to the operations of the user. The record file, being saved separately, can also be displayed, saved, edited, opened, called, copied, or printed. In addition, the image data, in the saved record file, can be associated with the spectral data corresponding to the current sample measurement device to be saved as a new record file. That is to say, when the association between the data is changed, the corresponding data is saved as a new record file.

The disclosure can record the corresponding sample measurement device of the spectral measurement and it can be conveniently consulted.

Preferably, this disclosure can also collect spectral measurement environment information and/or user-input text record information, and the spectral measurement environment information and/or user-input text record information are associated with the spectral data and image data to be saved as a record file. The spectral measurement environment information comprises operator information, sample information, and sample measurement device information. Thus, the user can make a written memo on the relevant information and data of the spectral measurement and fill in the information to save the information, and record the sample and the corresponding measurement equipment used in the spectral measurement.

In the block 205, when receiving commands of viewing, comparing, or editing a record file, the step of displaying the corresponding image data or video data of the record file also comprises a step of stopping displaying the currently collected image data and/or pausing to record video of the sample measurement device in real time. That is to say, when the user records the current sample measurement device or needs to view and compare with the previous measurement record, the host computer stops displaying or recording the current sample measurement device and displays the image data (photo data or recorded video data) of the previous record file. The user can operate the host computer to display the image of the current sample measurement device or restore video record, when finishing viewing, comparing, or editing. Thus, it can avoid the previous sample measurement device being recorded incorrectly during the process of recording the images, and it also can avoid that the spectral data in the record file not corresponding to the image data of the sample measurement device.

In addition, in the disclosure, the image data, being saved in the record file, can also be associated with the spectral data corresponding to the current sample measurement device to be saved as a new record file. That is to say, during a process of the user is recording, the user can associate the image data with the spectral data of the current sample measurement device through calling the previously saved record file and save the associated image data and spectral data as a new record file.

In the spectral display method with photographic function, the measured spectral data and the image of the sample measurement device can be displayed on a display interface, and the previously saved record file can also be displayed. Specifically, the spectral display method with photographic function also comprises a step of controlling to display a spectral curve window, a record input window, and an experiment chart window. The record input window comprises an image display window and a text input window.

The experiment chart window comprises an experiment chart operation command window and an experiment chart storage window. The collected spectral data or the recorded spectral data recorded in the record file is displayed on the spectral curve window. The collected image data of the sample measurement device or the image data being called from the record file is displayed on the image display window, or other image data obtained from the host computer is displayed on the image display window. The associated spectral data and image data are regarded as a cache to be displayed on the experiment chart storage window. The saved record file, the collected image data of the sample measurement device, or other image data is displayed on the experiment chart storage window. Specifically, the other image data is photo data or video data obtained from a shooting system of other disclosure, but not this disclosure, such as other picture files or camera files from the host computer.

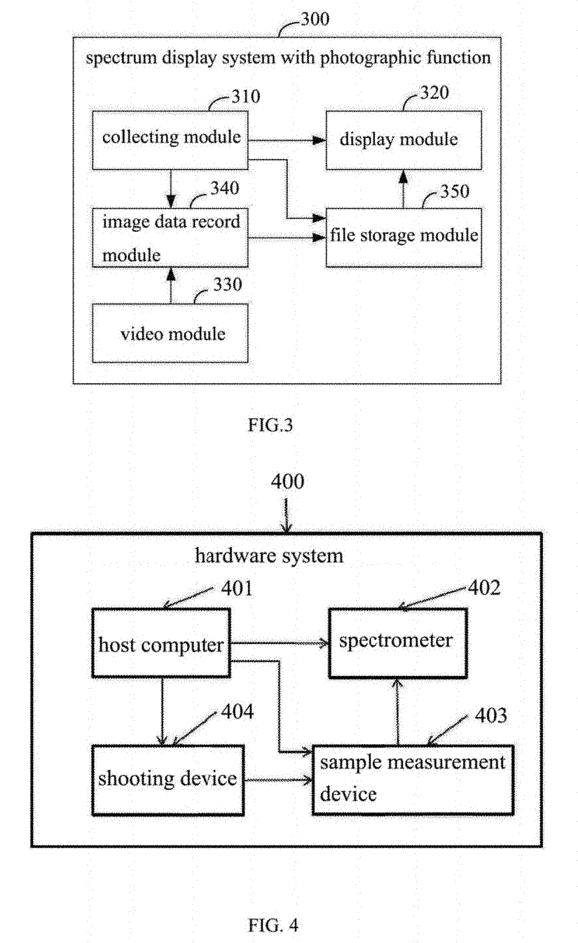

FIG. 3 illustrates a spectrum display system with photographic function 300. The spectrum display system with photographic function 300 comprises a collecting module 310, a display module 320, a video module 330, an image data record module 340, and a file storage module 350. The collecting module 310 is coupled to the display module 320, the image data record module 340, and the file storage module 350. The display module 320 is coupled to the file storage module 350. The image data record module 340 is coupled to the file storage module 350.

The collecting module 310 is configured to collect the spectral data and image data of the sample measurement device. The sample measurement device comprises the sample.

The display module 320 is configured to control the spectral data and the image data of the sample measurement device to display on the host computer. The display module 320 is also configured to load image data from a record file to display on the host computer when receiving the commands of viewing, comparing, or editing the record file.

The video module 330 is configured to control the shooting device to display the captured image on the record input window upper portion in real time, and records the image data of the sample measurement device according to the commands of shooting or recording the sample measurement device. The image data comprises photo data of shooting the sample measurement device or recorded video data of recording the sample measurement device.

The image data record module 340 is configured to place the associated spectrum data and image data into the experiment chart storage window for performing corresponding operations. The image data record module 340 is also configured to perform loading operations with the saved record file and obtain the associated spectrum data and image data for corresponding operations.

The file storage module 350 is configured to save the associated spectral data and image data as a record file. The file storage module 350 is also configured to save the photo data or video data separately as a record file.

The collecting module 310 is also configured to collect the spectral measurement environment information and/or user-input text record information. The spectral measurement environment information comprises the operator information, the sample information, and the sample measurement device information. The file storage module 350 is also configured to save the associated spectral measurement environment information and/or user-input text record information, the spectral data, and the image data as a record file, after the spectral measurement environment information and/or user-input text record information are associated with the spectral data and image data.

The display module 320 is also configured to stop displaying the currently collected image data in real time when receiving commands of viewing, comparing, or editing the record file. The image data record module 330 is also configured to pause to take of a photograph or recording of an image of the sample measurement device when receiving the commands of viewing, comparing, or editing the record file.

The file storage module 340 is also configured to save the associated image data in the saved record file and spectral data corresponding to the current sample measurement device as a record file, after the image data in the saved record file is associated with the spectral data corresponding to the current sample measurement device.

The display module 320 is also configured to control to display the spectral curve window, the record input window, and the experiment chart window. The record input window comprises an image display window and a text input window. The experiment chart window comprises an experiment chart operation command window and an experiment chart storage window. The display module 320 is also configured to display the collected spectral data on the spectral curve window. The display module 320 is also configured to display the collected image data of the sample measurement device or the image data being called from the record file on the image display window, or display other image data obtained from the host computer on the image display window. The display module 320 is further configured to regard the associated spectral data and image data as a cache to display on the experiment chart storage window. The display module 320 is further configured to display the saved record file, the collected image data of the sample measurement device, or other image data from the host computer on the experiment chart storage window. Specifically, the other image data is photo data or video data obtained from a shooting system of other disclosure, but not this disclosure, such as other picture files or camera files from the host computer.

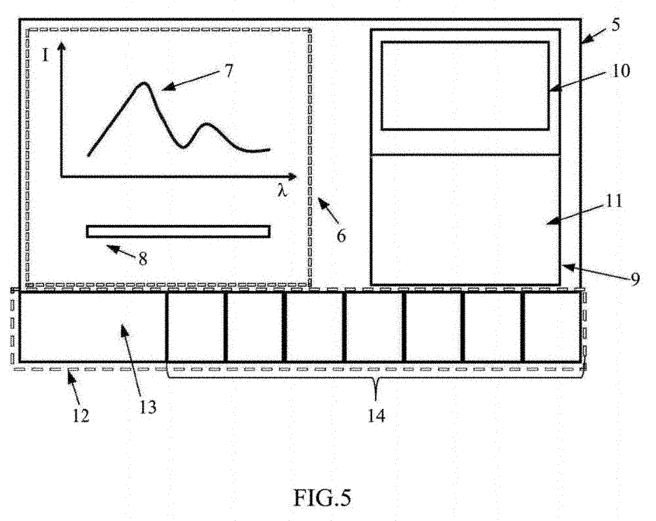

FIG. 4 illustrates a block diagram of one exemplary embodiment of a hardware system 400. The hardware system 400 comprises a host computer 401, a spectrometer 402, a sample measurement device 403, and a shooting device 404. The host computer 401 is configured to control the spectrometer 402 and the shooting equipment 404 through the same man-machine software interface. The spectrometer 402 is configured to measure spectrum. The shooting equipment 404 is configured to record the sample measurement device 403. The sample measurement device 403 comprises a sample.

FIG. 5 illustrates a schematic diagram of one embodiment of an interface of a spectrograph with photographic and/or video function. FIG. 5 illustrates a man-machine software interface 5, a spectral curve window 6, a spectral curve 7, an optical chromatogram 8, a record input window 9, a record input window upper portion 10, a record input window lower portion 11, an experiment chart window 12, an experiment chart operation command window 13, and an experiment chart storage window 14. In the optical chromatogram 8, each color is used to mark one corresponding light, the conventional visible light chromatograms is used for the visible light, the black is used for ultraviolet spectrum with wavelengths less than 380 nanometres (nm), and the white is used for near infrared spectra with wavelengths greater than 780 nm.

The man-machine software interface 5 of a computer 1 controls the spectrometer 2 to measure the spectrum and obtain the spectral curve 7. The used sample measurement device and sample or other relevant equipment used for measuring the spectrum, the operator can display the image of the sample measurement device on the record input window upper portion 10 in real time, and if necessary, the operator can photograph the image and statically display the photo on the record input window upper portion 10.

Corresponding textual record can be recorded on the record input window lower portion 11. The photo on the record input window upper portion 10 and the textual record on the record input window lower portion 11 constitute one information record. The spectral measurement results together with the relevant measurement data recorded by the photograph are regarded as a file to be disposed, such as be displayed, be saved, be edited, be opened, be invoked, be copied, and be printed. The operator can place the photos or video images from the record input window upper portion 10 into the experiment chart storage window 14 of the spectral curve window 6 in order. The commands from the experiment chart operation command window 13 are used to view or compare the images. The relevant commands of the experiment chart operation command window 13 can be operated to control the experiment chart storage window 14 to perform corresponding operations.

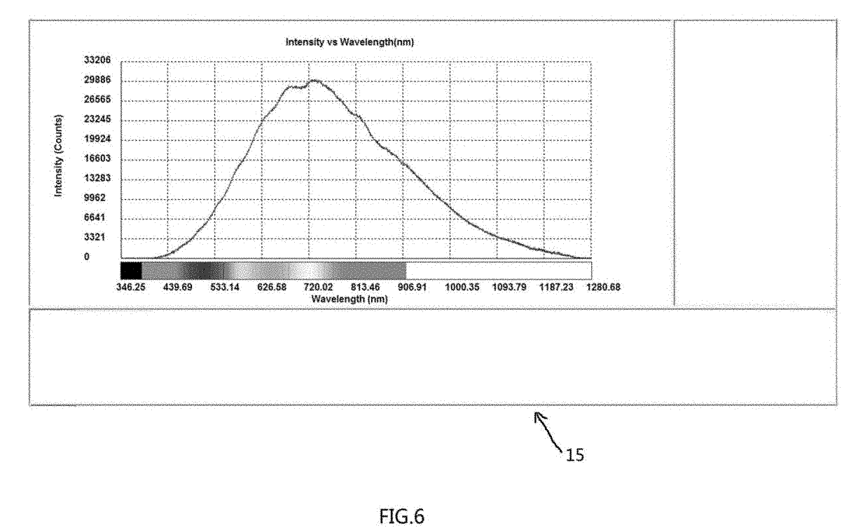

FIG. 6 is a partial schematic diagram of an embodiment of a software interface of a host computer. FIG. 6 illustrates a spectrometer setting window 15, the spectral curve 7 (labeled in FIG. 5), the optical chromatogram 8 (labeled in FIG. 5), and the record input window 9 (labeled in FIG. 5). The spectrometer setting window 15 comprises a plurality of setting buttons (not shown). The plurality of setting buttons can be operated by the user to perform some corresponding operations.

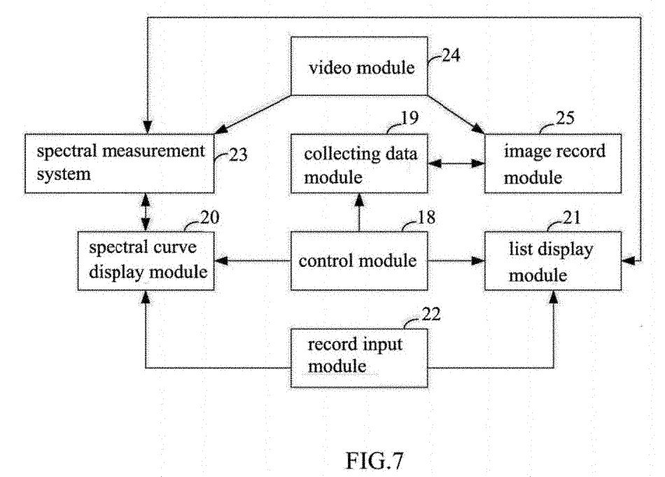

FIG. 7 illustrates a system architecture diagram of an embodiment of the spectrum display system with photographic function. FIG. 7 illustrates a control module 18, a collecting data module 19, a spectral curve display module 20, a list display module 21, a record input module 22, a spectral measurement system 23, a video module 24, and an image record module 25. The spectral measurement system 23 comprises a spectrometer for measuring spectra, a sample measurement device, other devices and/or equipment.

The control module 18 controls the collecting data module 19, the spectral curve display module 20, and the list display module 21 to performance corresponding operations. Through controlling the spectrum measurement system 23, the collecting data module 19 collects the original spectrum data and saves the collected original spectrum data to the host computer, thereby enabling the collected original spectrum data which is saved in the host computer to be called by the spectral curve display module 20 and the list display module 21. Specifically, through the host computer, a spectrometer circuit, an optical system, and a multi-element photoelectric detector, the collecting data module 19 collects the original spectrum data and saves the collected original spectrum data to the host computer. The spectral curve display module 20 displays the spectral curve 7 and all spectral data corresponding to the spectral curve 7. The spectral curve display module 20 also comprises a light chromatogram 8. The light chromatogram 8 is configured to be visually compared with the spectral curve 7. The data displayed on the spectral curve display module 20 is related to the sample measurement device and the test data of the spectral measurement system 23, thus the measured spectral curve 7 corresponds to the setting information and shooting image of the spectral curve window 6. The association can be marked with a digitally encoded tag, that is to say, the same digital tag on the spectral curve window 6 and the shooting image is regarded as a marker of one same file.

The list display module 21 displays all spectral data corresponding to the spectral curve 7 by a list manner. The list display module 21 comprises a function of turning on/off selection.

The display data displayed by the list display module 21 are also associated with the sample measurement device and the test data of the spectral measurement system 23. The record input module 22 provides a record input window 9 on the spectrum curve window 6. The record input window 9 is displayed, saved, edited, opened, called, copied, and printed together with the spectrum curve window 5 as a file. The record input window 9 can also be displayed, saved, edited, opened, called, copied, and printed as a single file. The record input module 22 is a separate module that is not controlled by the control module 18. The record input module 22 can finish operations of the record input window 9. The video module 24 controls the shooting device to display the captured image on a record input window upper portion 10 in real time. The live image can be photographed or recorded as needed by the video module 24. The image record module 25 is configured to place the photos or video images on the record input window upper portion 10 to the experiment chart window 12 of the spectral curve window 6 in order. The commands from the experiment chart operation command window 13 are used to view or compare the images. In addition, the image record module 25 is operated to open the saved photos, videos, or other pictures on the record input window upper portion 10.

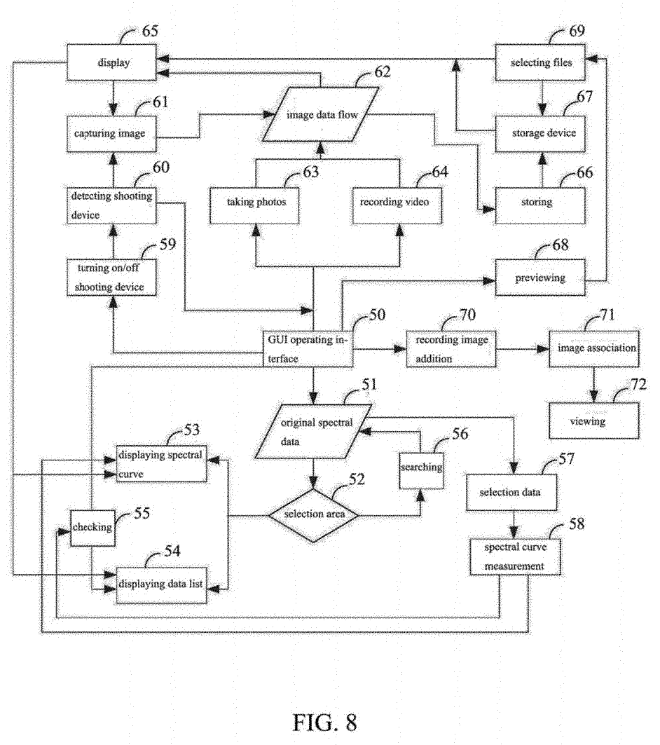

FIG. 8 illustrates an operating flowchart of an embodiment. FIG. 8 illustrates a GUI operating interface 50, a collected original spectral data 51 (data cache), a selection area 52 of the original spectral data, an operation of displaying spectral curve 53, an operation of displaying data list 54, an operation of checking 55, an operation of searching 66, an operation of selection data 57, an operation of spectral curve measurement 58, an operation of turning on/off shooting device 59, an operation of detecting shooting device 60, an operation of capturing image 61, an image data flow 62, an operation of taking photos 63, an operation of recording video 64, an operation of storing 66, a storage device 67, an operation of display previewing 68, an operation of selecting files 69, an operation of recording image addition 70, an operation of image association 71, and an operation of viewing 72. Open a spectrograph function software, then the GUI operating interface 50 is displayed. After completing a series of settings, click the key of the original spectral data, the control module 18 controls the collecting data module 19 to complete collecting the original spectral data (data cache) and save the collected data into the host computer to form the original spectrum database 51. Then, determine whether the selection region 52 is selected to be no, if the selection region 52 is selected to be no, perform the operation of displaying spectral curves 53 and displaying data list 54. Displaying data list 54 is controlled by checking 55, thus performing checking 55 can control to turn on/off data list. If the selection region 52 is selected to be yes, perform the operation of searching 66 to search the original spectral data 51 to obtain the original spectral data 51 with data selection 57, then boot loading selection box, cursor, and ruler, the operator can operate the spectral curve measurement 58 if he needs. That is to say, operating the cursor and the ruler to measure data of a spectral curve, such as peak or half width, and the measured data is displayed on displaying spectral curves 53 and displaying data list 54 and is refreshed to displayed on the spectrometer setting window 15.

The turning on/off shooting device 59 is used to turn the shooting device on or off, to record the information of the samples and other devices related to the measured spectra intuitively and accurately for the operator. The detecting shooting device 60 is operated to detect whether the shooting device is connected normally, and if the shooting device is connected normally, the capturing image 61 is operated to capture the live image data stream 62 corresponding to the shooting images, and the display 65 is operated to display the live image data stream 62 on the record input window upper portion 10. The taking photo 63 is operated to take a photo record, and the storing 66 is operated to save the shooting photos into the storage device 67. The operation of taking photos can be performed when or after the spectra is measured. Based on the same principle, the video recording 64 can be operated to record videos, and the storing 66 is operated to save the recorded videos into the storage device 67. The operation of recording videos can be performed when or after the spectra is measured.

In addition, the recording image addition 70 is operated to place the photos or video images marked by the image association 71 and the spectral curve 7 into the experiment chart storage window 14 of the spectral curve window 6 in order. The examining 72 and the commands of the experiment chart operation command window 13 are operated to view, compare, or edit the images.

In order to easier view or compare the saved photos or videos or other pictures, the previewing 68 and the selecting files 69 can be operated to open the saved photos or videos or other pictures from the storage device 67. The display 65 is operated to display the opened photos or videos or other pictures on the record input window upper portion 10. The capturing image 61 pauses when the display 65 is operated to display the opened photos or videos or other pictures. On the contrary, when the opened photos or videos or other pictures needn't to be displayed, the capturing image 61 is operated to continue capturing the relevant display 65.

The exemplary embodiments shown and described above are only examples. Many details are often found in the art such as the other features of a spectrum display method and system with photographic function. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A spectrum display method with photographic function, comprising:
collecting spectral data and image data of a sample measurement device, the sample measurement device comprising a sample;
the spectral data and the image data of the sample measurement device being controlled to display;
recording the image data of the sample measurement device according to commands of shooting or recording the sample measurement device, the image data comprising photo data of shooting the sample measurement device or recorded video data of recording the sample measurement device; and
saving the associated spectral data and image data as a record file, the record file configured to be viewed, compared, or edited, saved.

2. The spectrum display method of claim 1, further comprising a step of placing the spectral data being associated with the image data into an experiment chart storage window for viewing, comparing, or editing the associated data.

3. The spectrum display method of claim 1, further comprising a step of loading the saved and associated image data and spectral data through commands for viewing, comparing, or editing.

4. The spectrum display method of claim 1, further comprising a step of the image data being saved separately as a record file, wherein the separately saved record file is configured to be viewed, compared, or edited, saved.

5. The spectrum display method of claim 1, wherein the spectral data is collected by a spectrometer and the image data of the sample measurement device is collected by a shooting device.

6. The spectrum display method of claim 1, further comprising a step of collecting spectral measurement environment information, wherein the spectral measurement environment information comprises operator information, sample information, and sample measurement device information.

7. The spectrum display method of claim 1, further comprising:
collecting spectral measurement environment information and/or user-input text record information; and
the spectral measurement environment information and/or user-input text record information being associated with the spectral data and image data to be saved as a record file;
wherein the spectral measurement environment information comprises operator information, sample information, and sample measurement device information.

8. The spectrum display method of claim 1, wherein when receiving commands of viewing, comparing, or editing the record file, the step of displaying the corresponding image data or video data of the record file also comprising:
stopping displaying the currently collected image data and/or pausing to record video of the sample measurement device in real time.

9. The spectrum display method of claim 1, further comprising:
controlling to display a spectral curve window, a record input window, and an experiment chart window, the record input window comprises an image display window and a text input window;
the collected spectral data or the recorded spectral data recorded in the record file being displayed on the spectral curve window;
the collected image data of the sample measurement device, the image data being called from the record file is displayed on the image display window, or other image data obtained from the host computer being displayed on the image display window; and
the associated spectral measurement environment information, spectral data, and image data are regarded as a cache to be displayed on the experiment chart storage window, the saved record file, the collected image data of the sample measurement device, or other image data is displayed on the experiment chart storage window.

10. The spectrum display method of claim 9, further comprising a step of the image data of the displayed record file being associated with the spectral data corresponding to the current sample measurement device to be saved as a new record file.

11. A spectrum display method with photographic function, comprising:
collecting spectral measurement environment information, spectral data, and image data of a sample measurement device, the spectral measurement environment information comprising operator information, sample information, and sample measurement device information, and the sample measurement device comprising a sample;
the spectral data and the image data of the sample measurement device being controlled to display;
recording the image data of the sample measurement device according to commands of shooting or recording the sample measurement device, the image data comprising photo data of shooting the sample measurement device or recorded video data of recording the sample measurement device; and
saving the associated spectral measurement environment information, spectral data, and image data as a record file; the associated spectral measurement environment information, spectral data, and image data configured to be viewed, compared, or edited, saved; or loading the saved and associated spectral measurement environment information, image data, and spectral data for viewing, comparing, or editing.

12. The spectrum display method of claim 11, further comprising:
collecting spectral measurement environment information and/or user-input text record information; and
the spectral measurement environment information and/or user-input text record information being associated with the spectral data and image data to be saved as a record file;
wherein the spectral measurement environment information comprises operator information, sample information, and sample measurement device information.

13. The spectrum display method of claim 11, wherein when receiving commands of viewing, comparing, or editing the record file, the step of displaying the corresponding image data or video data of the record file also comprising:
stopping displaying the currently collected image data and/or pausing to record video of the sample measurement device in real time.

14. The spectrum display method of claim 11, further comprising:
controlling to display a spectral curve window, a record input window, and an experiment chart window, the record input window comprises an image display window and a text input window;
the collected spectral data or the recorded spectral data recorded in the record file being displayed on the spectral curve window;
the collected image data of the sample measurement device, the image data being called from the record file is displayed on the image display window, or other image data obtained from the host computer being displayed on the image display window; and
the associated spectral measurement environment information, spectral data, and image data being regarded as a cache to be displayed on the experiment chart storage window, the saved record file, the collected image data of the sample measurement device, or other image data is displayed on the experiment chart storage window.

15. The spectrum display method of claim 14, further comprising a step of the image data of the displayed record file being associated with the spectral data corresponding to the current sample measurement device to be saved as a new record file.

16. A spectrum display system with photographic function, comprising:
a collecting module configured to collect spectral measurement environment information, spectral data, and image data of a sample measurement device, the spectral measurement environment information comprising operator information, sample information, and sample measurement device information, and the sample measurement device comprising a sample;
a display module configured to:
display the spectral data and the image data of the sample measurement device; and
display the associated image data of an experiment chart storage window when receiving commands of viewing, comparing, or editing from a host computer;
a video module configured to control a shooting device to display the shoot image on a record input window upper portion in real time, and record the image of the sample measurement device according to commands of shooting or recording the sample measurement device, the image data comprising photo data of shooting the sample measurement device or recorded video data of recording the sample measurement device;
an image data record module is configured to:
place the associated spectral measurement environment information, spectrum data, and image data into an experiment chart storage window for performing corresponding operations; and
perform loading operations with the saved record file and obtain the associated spectral measurement environment information, spectrum data, and image data for corresponding operations; and
a file storage module is configured to:
save the associated spectral measurement environment information, spectral data, and image data as a record file; and
save the photo data or video data separately as a record file.

17. The spectrum display system of claim 16, wherein the collecting module is also configured to collect spectral measurement environment information and/or user-input text record information; and the file storage module is also configured to save the associated spectral measurement environment information and/or user-input text record, the spectral data, and the image data to be saved as a record file.

18. The spectrum display system of claim 16, wherein the display module is also configured to stop displaying the currently collected image data in real time, when receiving the commands of viewing, comparing, or editing the record file; the image data record module is also configured to pause to record video of the sample measurement device when receiving the commands of viewing, comparing, or editing the record file.

19. The spectrum display system of claim 16, wherein the file storage module is also configured to save the associated image data of the saved record file and the spectral data corresponding to the current sample measurement device as a new record file.

20. The spectrum display system of claim 19, wherein the display module is also configured to:
control to display a spectral curve window, a record input window, and an experiment chart window; the record input window comprises an image display window and a text input window;
display the collected spectral data or the recorded spectral data recorded in the record file on the spectral curve window;
display the collected image data of the sample measurement device, the image data being called from the record file on the image display window, or display other image data obtained from the host computer on the image display window;
regard the associated spectral measurement environment information, spectral data, and image data as a cache to display on the experiment chart storage window; and
display the saved record file, the collected image data of the sample measurement device, or other image data on the experiment chart storage window.
